(19) United States
(12) Patent Application Publication
(10) Pub. No.: US 2026/0292658 A1
(43) Pub. Date: Sep. 24, 2026

(54) METHOD, DEVICE, AND MEDIUM FOR DOWNLINK LOAD AND SINR-BASED RSRQ VALUES FOR CELL SELECTION AND RESELECTION

(71) Applicant: Verizon Patent and Licensing Inc., Basking Ridge, NJ (US)

(72) Inventors: Asif Dawoodi Gandhi, Edison, NJ (US); Vaughne Glymph, Pittsburgh, PA (US); Brien L. Range, Belle Mead, NJ (US); Chin Chiu, Allen, TX (US); Corey J. Christopherson, Bainbridge Island, WA (US)

(21) Appl. No.: 19/083,672

(22) Filed: Mar. 19, 2025

(51) Int. Cl. H04W 48/08; H04B 17/318; H04B 17/336; H04W 36/00

(52) U.S. Cl. CPC H04W 48/08; H04B 17/328; H04B 17/336; H04W 36/0085

(57) ABSTRACT

A method, a network device, and a non-transitory computer-readable storage medium are described in relation to a load and signal-to-interference-plus-noise ratio (SINR)-based reference signal received quality (RSRQ) for cell selection and reselection service. The load and SINR-based RSRQ for cell selection and reselection service may provide for the calculation of a parameterized RSRQ value based on a prospective downlink (DL) cell load value and a target DL SINR value that is context-dependent. The load and SINR-based RSRQ for cell selection and reselection service may provide the parameterized RSRQ value to end device, which may be used for cell selection and cell reselection, and consequently improve radio connectivity and radio management.

### BACKGROUND

Development and design of networks present certain challenges from a network-side perspective and an end device perspective. For example, the establishment and maintenance of end device connectivity in a radio network environment present technical challenges. An end device may be configured to perform a cell selection or a cell reselection procedure when certain criteria is satisfied.

### BRIEF DESCRIPTION OF THE DRAWINGS

FIG. 1A is a diagram illustrating an exemplary relationship between RSRQ and downlink load;

FIG. 1B is a diagram illustrating an exemplary environment in which an exemplary embodiment of a load and SINR-based RSRQ for cell selection and reselection service may be implemented;

FIGS. 2A-2D is a diagram illustrating an exemplary process of an exemplary embodiment of the load and SINR-based RSRQ for cell selection and reselection service;

FIG. 3 is a diagram illustrating exemplary components of a device that may correspond to one or more of the devices illustrated and described herein; and

FIG. 4 is a flow diagram illustrating an exemplary process of an exemplary embodiment of the load and SINR-based RSRQ for cell selection and reselection service.

### DETAILED DESCRIPTION

The following detailed description refers to the accompanying drawings. The same reference numbers in different drawings may identify the same or similar elements. Also, the following detailed description does not limit the invention.

Cell selection and reselection in idle mode for user equipment (UE) in Fourth Generation (4G) and Fifth Generation (5G) radio environments may be performed based on reference signal received power (RSRP) and reference signal received quality (RSRQ) values. For example, according to network standards, such as Third Generation Partnership Project (3GPP), 3GPP2, International Telecommunication Union (ITU), European Telecommunications Standards Institute (ETSI), GSM Association (GSMA), or the like pertaining to 5G radio environments, cell selection criteria S is based on RSRP and RSRQ related values, such as Qᵣₓₗₑᵥₘₑₐₛ, Qᵣₓₗₑᵥₘᵢₙ, Q_{qualmeas}, Q_{qualmin}, etc., associated with Srxlev, Squal, and similar criteria values.

Current network standards do not consider other relevant factors such as downlink (DL) signal-to-interference-to-noise (SINR) ratio, DL cell load, and transmission resources of a radio access network (RAN) device (e.g., number of transmit antennas) that may impact cell selection and reselection. Additionally, at least some of these other relevant factors may be time and cell dependent. For example, the DL cell load and DL SINR may vary over time and be frequency/frequency band dependent. As a consequence, RSRQ values may be inadequate or sub-optimal criteria for cell selection and reselection.

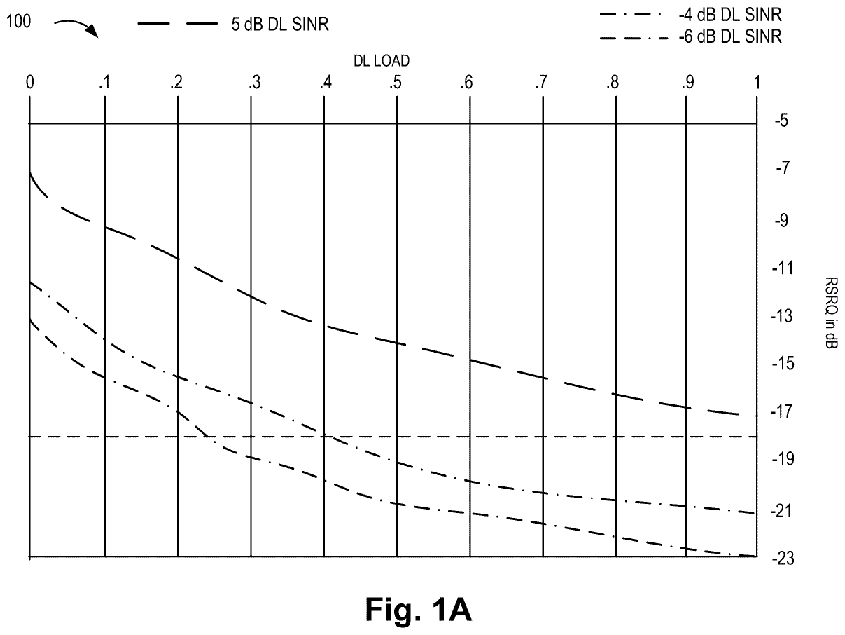

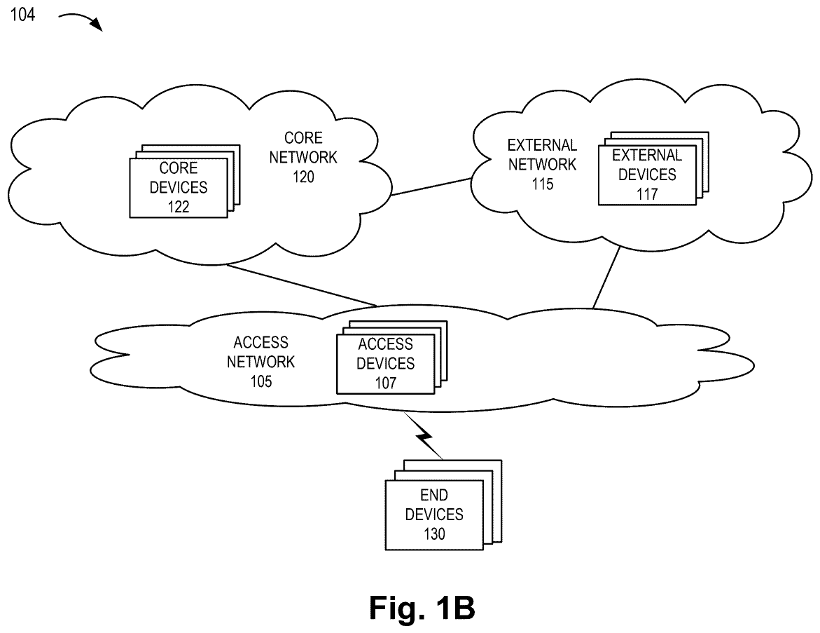

FIG. 1A is an exemplary graph 100 that illustrates a relationship between RSRQ values and DL cell load. As illustrated, in relation to a −18 dB RSRQ, at about 40% DL load, the DL SINR value corresponds to a −4 dB DL SINR value. According to another example, in relation to the same RSRQ value, at about 25% DL load, the DL SINR value corresponds to a −6 dB DL SINR value. In either of these cases, the DL SINR values may yield poor performance. In contrast, a 5 dB DL SINR value may yield good performance at any DL load value relative to the −18 dB RSRQ, as shown.

According to exemplary embodiments, a load and SINR-based RSRQ for cell selection and reselection service is described. According to various exemplary embodiments, the load and SINR-based RSRQ for cell selection and reselection service may be implemented for idle mode, connected mode, or both associated with end devices, as described herein. According to various exemplary embodiments, the load and SINR-based RSRQ for cell selection and reselection service may be implemented for cell selection, cell reselection, handovers (HO) (e.g., inter-frequency (e.g., between source and target access devices, or different radio bands hosted by a source access device), intra-frequency(e.g., between source and target access devices), cell redirection, adding cells for uplink (UL)/DL carrier aggregation (CA), and other types of radio connectivity-based procedures, as described herein. Given the various contexts to which the load and SINR-based RSRQ for cell selection and reselection service may apply, cell reselection may be interpreted to include handover and cell redirection. According to various exemplary embodiments, the load and SINR-based RSRQ for cell selection and reselection service may be implemented in 4G and 4G Advanced wireless environments, 5G wireless environments, or future generation wireless environments (e.g., 5G Advanced, Sixth Generation (6G), Seventh Generation (7G), etc.).

According to an exemplary embodiment, the load and SINR-based RSRQ for cell selection and reselection service may include calculating parameterized RSRQ values based on DL SINR values, DL cell load values, and transmission resources of a RAN device, as described herein. According to various exemplary embodiments, the DL SINR value may depend on various contexts, such as idle mode, connected mode, cell selection, cell reselection, ranking (e.g., lower priority, higher priority), 4G versus 5G, source cell, target cell, and so forth. According to some exemplary embodiments, a prospective DL cell load may be estimated based on an artificial intelligence and/or machine learning (AI/ML) model, as described herein.

According to an exemplary embodiment, the load and SINR-based RSRQ for cell selection and reselection service may include generating a message that includes the parameterized RSRQ value. The load and SINR-based RSRQ for cell selection and reselection service may include transmitting the message to an end device, as described herein. The end device may use the parameterized RSRQ value as a basis for cell selection or cell reselection, as described herein.

In view of the foregoing, the load and SINR-based RSRQ for cell selection and reselection service may enable a mapping between RSRQ and DL SINR, DL cell load, and transmission resources of a RAN device (e.g., number of antennas, radio frame structure, etc.). As a result, the load and SINR-based RSRQ for cell selection and reselection service may provide a parameterized RSRQ value that accounts for different DL load states (e.g., no DL load to full DL load) associated with a cell (e.g., carrier frequency, frequency band, or the like), RAN device configuration (e.g. number of antennas, ports, etc., in the DL, etc.), and a context-dependent target DL SINR, as described herein, that may improve radio connectivity and the management thereof.

FIG. 1B is a diagram illustrating an exemplary environment 104 in which an exemplary embodiment of load and SINR-based RSRQ for cell selection and reselection service may be implemented. As illustrated, environment 104 includes an access network 105, an external network 115, and a core network 120. Access network 105 includes access devices 107 (also referred to individually or generally as access device 107). External network 115 includes external devices 117 (also referred to individually or generally as external device 117). Core network 120 includes core devices 122 (also referred to individually or generally as core device 122). Environment 104 further includes end devices 130 (also referred to individually or generally as end device 130).

The number, type, and arrangement of networks illustrated in environment 104 are exemplary. For example, according to other exemplary embodiments, environment 104 may include fewer networks, additional networks, and/or different networks. For example, according to other exemplary embodiments, other networks not illustrated in FIG. 1B may be included, such as an X-haul network (e.g., backhaul, mid-haul, fronthaul, etc.), a transport network (e.g., Signaling System No. 7(SS7 ), an optical network, a wired network, etc.), a time-sensitive network (TSN) system, a deterministic networking (DetNet) network, or another type of network that may support a wireless service and/or an application service, as described herein.

A network device, a network element (NE), or a network function (NF) (referred to herein simply as a network device) may be implemented according to one or multiple network architectures, such as a client device, a server device, a peer device, a proxy device, a cloud device, and/or a virtualized network device. Additionally, a network device may be implemented according to various computing architectures, such as centralized, distributed, cloud (e.g., elastic, public, private, etc.), edge, fog, and/or another type of computing architecture, and may be incorporated into distinct types of network architectures (e.g., Software Defined Networking (SDN), virtual, logical, etc.), as well as used to support other types of network elements (e.g., network slices, quality of service (QoS) flows, packet data unit (PDU) sessions, channels, network paths, tunnels, etc.). The number, the type, and the arrangement of network devices are exemplary.

Environment 104 includes communication links between the networks and between the network devices. Environment 104 may be implemented to include wired, optical, and/or wireless communication links. A communicative connection via a communication link may be direct or indirect. For example, an indirect communicative connection may involve an intermediary device and/or an intermediary network not illustrated in FIG. 1B. A direct communication connection may not involve an intermediary device and/or an intermediary network. The number, type, and arrangement of communication links illustrated in environment 104 are exemplary.

Environment 104 may include various planes of communication including, for example, a control plane, a user plane, a service plane, a network management plane, an artificial intelligence and/or a machine learning (AI/ML) (control) plane, and a future generation plane, or a subset thereof. Environment 104 may include other types of planes of communication. A message communicated in support of the load and SINR-based RSRQ for cell selection and reselection service may use at least one of these planes. For example, the message of an exemplary embodiment of load and SINR-based RSRQ for cell selection and reselection service may use the control plane. According to various exemplary implementations, the interface of the network device may be an SBI, a reference point-based interface, an Open Radio Access Network (O-RAN) interface, a 5G interface, another generation of interface (e.g., 5G Advanced, 6G, 7G, 4G, etc.), or some other type of network interface (e.g., proprietary, etc.).

Access network 105 may include one or multiple networks of one or multiple types and technologies. For example, access network 105 may be implemented to include a terrestrial network, a non-terrestrial network (e.g., a satellite network, an air-based network, etc.), or a combination thereof. By way of further example, access network 105 may include a 5G RAN, a future generation RAN (e.g., a 6G RAN, a 7G RAN, or a subsequent generation RAN), a centralized-RAN (C-RAN), an O-RAN, and/or another type of access network. Access network 105 may include a legacy RAN (e.g., a Third Generation (3G) RAN, a 4G or 4.5 RAN (Long Term Evolution (LTE) Advanced (LTE-A), LTE Advanced Pro (LTE-A Pro), etc.). Access network 105 may communicate with and/or include other types of access networks, such as, for example, a Wi-Fi® network, a local area network (LAN), a Citizens Broadband Radio System (CBRS) network, a cloud RAN, an O-RAN, a virtualized RAN (vRAN), a self-organizing network (SON), a wired network (e.g., optical, cable, etc.), or another type of network that provides access to or can be used as an on-ramp to access network 105.

Access network 105 may include different and multiple functional splitting, such as options 1, 2, 3, 4, 5, 6, 7, or 8 that relate to combinations of access network 105 and core network 120, or the splitting of the various layers (e.g., physical layer, media access control (MAC) layer, radio link control (RLC) layer, and packet data convergence protocol (PDCP) layer, etc.), plane splitting (e.g., user plane, control plane, etc.), interface splitting (e.g., F1-U, F1-C, E1, Xn-C, Xn-U, X2-C, Common Public Radio Interface (CPRI), etc.) as well as other types of network services, such as dual connectivity (DC) or higher (e.g., a secondary cell group (SCG) split bearer service, a master cell group (MCG) split bearer, an SCG bearer service, non-standalone (NSA), standalone (SA), etc.), carrier aggregation (CA) (e.g., intra-band, inter-band, contiguous, non-contiguous, etc.), edge and core network slicing, coordinated multipoint (CoMP), various duplex schemes (e.g., frequency division duplex (FDD), time division duplex (TDD), half-duplex FDD (H-FDD), etc.), and/or another type of connectivity service (e.g., NSA, NR, SA NR, etc.). Additionally, or alternatively, according to some exemplary embodiments, access network 105 may be implemented to include various wired and/or optical architectures for wired and/or optical access services.

Depending on the implementation, access network 105 may include one or multiple types of network devices, such as access devices 107. For example, access device 107 may include a next generation Node B (gNB), an enhanced LTE (eLTE) evolved Node B (eNB), an eNB, a radio network controller (RNC), a radio intelligent controller (RIC), a base station (BS), a base station controller (BSC), a remote radio head (RRH), a baseband unit (BBU), a radio unit (RU), a remote radio unit (RRU), a centralized unit (CU), a CU-control plane (CP), a CU-user plane (UP), a distributed unit (DU), a small cell node (e.g., a picocell device, a femtocell device, a microcell device, a home eNB, a home gNB, etc.), an open network device (e.g., O-RAN Centralized Unit (O-CU), O-RAN Distributed Unit (O-DU), O-RAN next generation Node B (O-gNB), O-RAN evolved Node B (O-eNB)), a 5G ultra-wide band (UWB) node, a future generation wireless access device (e.g., a 5G advanced wireless station, a 6G wireless station, a 7G wireless station, or another generation of wireless station), or another type of cellular wireless station. Access devices 107 may also include a network device that provides a transport service (e.g., routing and forwarding), such as a router, a switch, or another type of layer 3 (e.g., network layer of the Open Systems Interconnection (OSI) model) network device.

According to some exemplary implementations, access device 107 may include a combined functionality of multiple radio access technologies (RATs) (e.g., 4G and 5G functionality, 5G and 5G Advanced functionality, 5G and 6G), etc.) via soft and hard bonding based on demands and needs. According to some exemplary implementations, access device 107 may include a split access device (e.g., a CU-control plane (CP), a CU-user plane (UP), etc.) or an integrated functionality, such as a CU-CP and a CU-UP, or other integrations of split RAN nodes. Access device 107 may be an indoor device or an outdoor device.

According to an exemplary embodiment, at least some of access devices 107 include logic of an exemplary embodiment of the load and SINR-based RSRQ for cell selection and reselection service, as described herein. According to an exemplary embodiment, access device 107 may calculate a parameterized RSRQ value based on a target DL SINR value, a DL cell load, and antenna resources of access device 107, as described herein.

According to various exemplary embodiments, the target DL SINR value may pertain to various Radio Resource Control (RRC) states associated with end device 130 (e.g., idle, connected, etc.) and various cell selection and reselection scenarios and contexts, such as measurement event types A, B, etc., priorities associated with cell reselection (e.g., higher, lower, etc.)), RATs, source cell, target cell, and other types of radio connectivity procedures, such as handover, DC, CA, etc.

According to various exemplary embodiments, the logic of the load and SINR-based RSRQ for cell selection and reselection service may use an AI/ML model to predict DL load values, logic that analyzes historical DL load value information associated with an antenna and a cell, or the like.

According to an exemplary embodiment, access device 107 may apply the parameterized RSRQ value to various cell selection and reselection parameter values that may typically be implemented as an RSRQ value according to a network standard, such as Q_{qualmin}, Thresh_{X,HighQ}, Thresh_{Serving,LowQ}, Thresh_{X,LowQ}, and other types of parameter values that may be used as a basis to calculate an RSRQ threshold value or a trigger for a cell selection or reselection procedure, for example.

According to an exemplary embodiment, access device 107 may generate and transmit a message, which includes the parameterized RSRQ value, to end device 130. For example, access device 107 may transmit or broadcast the message as a system information block (SIB) message, such as a SIB Type 1, a SIB Type 2, a SIB Type 3, a SIB Type 4, and so forth, depending on the context to which the parameterized RSRQ value pertains, a network standard, and the like. End device 130 may store and utilize the parameterized RSRQ value for a cell selection or reselection procedure according to the appropriate context.

External network 115 may include one or multiple networks of one or multiple types and technologies that provide an application service. For example, external network 115 may be implemented using one or multiple technologies including, for example, network function virtualization (NFV), software defined networking (SDN), cloud computing, Infrastructure-as-a-Service (IaaS), Platform-as-a-Service (PaaS), Software-as-a-Service (SaaS), or another type of network technology. External network 115 may be implemented to include a cloud network, a private network, a public network, a multi-access edge computing (MEC) network, a fog network, the Internet, a packet data network (PDN), a service provider network, the World Wide Web (WWW), an IP Multimedia System (IMS) network, a Rich Communication Service (RCS) network, a software defined (SD) network, a virtual network, a packet-switched network, a data center, or other type of network that may provide access to and may host an end device application service or a network application service.

Depending on the implementation, external network 115 may include various network devices such as external devices 117. For example, external devices 117 may include virtual network devices (e.g., virtualized network functions (VNFs), servers, host devices, containers, hypervisors, virtual machines (VMs), network function virtualization infrastructure (NFVI), and/or other types of virtualization elements, layers, hardware resources, operating systems, engines, etc.) that may be associated with application services for use by end devices (not illustrated). By way of further example, external devices 117 may include mass storage devices, data center devices, NFV devices, SDN devices, cloud computing devices, platforms, and other types of network devices pertaining to various network-related functions, as described herein. External network 115 may include one or multiple types of core devices 122, as described herein.

External devices 117 may host one or multiple types of application services. For example, the application services may pertain to broadband services in dense areas (e.g., pervasive video, smart office, operator cloud services, video/photo sharing, etc.), broadband access everywhere (e.g., ultra-low-cost network, etc.), enhanced mobile broadband (eMBB), higher user mobility (e.g., high speed train, remote computing, moving hot spots, etc.), Internet of Things (IoT) services (e.g., smart wearables, sensors, mobile video surveillance, smart cities, connected home, massive IoT (mIoT), critical IoT (cIoT), etc.), extreme real-time communications (e.g., tactile Internet, augmented reality (AR), virtual reality (VR), eXtended reality (XR), mixed reality (MR), etc.), lifeline communications (e.g., natural disaster, emergency response, etc.), ultra-reliable communications (e.g., automated traffic control and driving, collaborative robots, health-related services (e.g., monitoring, remote surgery, etc.), drone delivery, public safety, etc.), broadcast-like services, communication services (e.g., email, text (e.g., Short Messaging Service (SMS), Multimedia Messaging Service (MMS), etc.), massive machine-type communications (mMTC), voice, conferencing, instant messaging), video streaming, gaming (e.g., cloud gaming (CG), etc.), and/or other types of wireless and/or wired application services.

External devices 117 may also include other types of network devices that support the operation of external network 115 and/or the provisioning of application services, such as an orchestrator, an edge manager, an operations support system (OSS), a local domain name system (DNS), registries, a gateway, and/or external devices 117 that may pertain to various network-related functions or services (e.g., security, management, charging, billing, authentication, authorization, policy enforcement, development, communication with other networks, etc.). External devices 117 may include non-virtual, logical, and/or physical network devices.

Core network 120 may include one or multiple networks of one or multiple network types and technologies. Core network 120 may include a complementary network of access network 105. For example, core network 120 may be implemented to include a 5G core network, an evolved packet core (EPC) of an LTE network, a future generation core network (e.g., a 5G Advanced, a 6G, a 7G, or another generation of core network), and/or another type of core network.

Depending on the implementation of core network 120, core network 120 may include diverse types of network devices that are illustrated in FIG. 1B as core devices 122. For example, core devices 122 may include a user plane function (UPF), a Non-3GPP Interworking Function (N3IWF), an AMF, an SMF, a UDM device, a unified data repository (UDR), an authentication server function (AUSF), a network slice selection function (NSSF), a network repository function (NRF), a policy control function (PCF), an NWDAF, a network exposure function (NEF), a service communication proxy (SCP), a Time Sensitive Communication and Time Sensitive Function (TSCTCF), a future generation core device (e.g., a 5G-Advanced core device, a 6G core device, a 7G core device, etc.), a service capability exposure function (SCEF), a lifecycle management (LCM) device, an application function (AF), a mobility management entity (MME), a packet gateway (PGW), an enhanced packet data gateway (ePDG), a serving gateway (SGW), a home agent (HA), a General Packet Radio Service (GPRS) support node (GGSN), a home subscriber server (HSS), an authentication, authorization, and accounting (AAA) server, a policy and charging rules function (PCRF), a policy and charging enforcement function (PCEF), and a charging system (CS), or a sub-combination thereof. Additionally, core devices 122 may include transport devices (e.g., routers or the like), and a transport control device, such as a path computation engine (PCE).

According to other exemplary implementations, core devices 122 may include additional, different, and/or fewer network devices than those described. For example, core devices 122 may include a non-standard or a proprietary network device, and/or another type of network device that may be well-known but not particularly mentioned herein. Core devices 122 may also include a network device that provides a multi-RAT functionality (e.g., 4G and 5G, 5G and 5G Advanced, 5G and 6G, etc.), such as an SMF with PGW control plane functionality (e.g., SMF+PGW-C), a UPF with PGW user plane functionality (e.g., UPF+PGW-U), and/or other types of combined nodes (e.g., an HSS with a UDM and/or UDR, an MME with an AMF, etc.). Also, core devices 122 may include a split core device 122. For example, core devices 122 may include a session management (SM) PCF, an access management (AM) PCF, a user equipment (UE) PCF, and/or another type of split architecture associated with another core device 122, as described herein.

End device 130 includes a device that may have communication capabilities (e.g., wireless, wired, optical, etc.). End device 130 may or may not have computational capabilities. End device 130 may be implemented as a mobile device, a portable device, a stationary device (e.g., a non-mobile device or a non-portable device), a device operated by a user, or a device not operated by a user. For example, end device 130 may be implemented as a smartphone, a mobile phone, a personal digital assistant, a tablet, a netbook, a wearable device (e.g., a watch, glasses, etc.), a computer (e.g., laptop, palmtop, etc.), a gaming device, a music device, an IoT device, a drone, a smart device, a television, a set top box, a media player or streaming device, a telematics device, or another type of wireless device (e.g., another type of UE). End device 130 may be configured to execute various types of software (e.g., applications, programs, etc.). The number and the types of software may vary among end devices 130. End devices 130 may include “edge-aware” and/or “edge-unaware” application service clients. For purposes of description, end device 130 is not considered a network device.

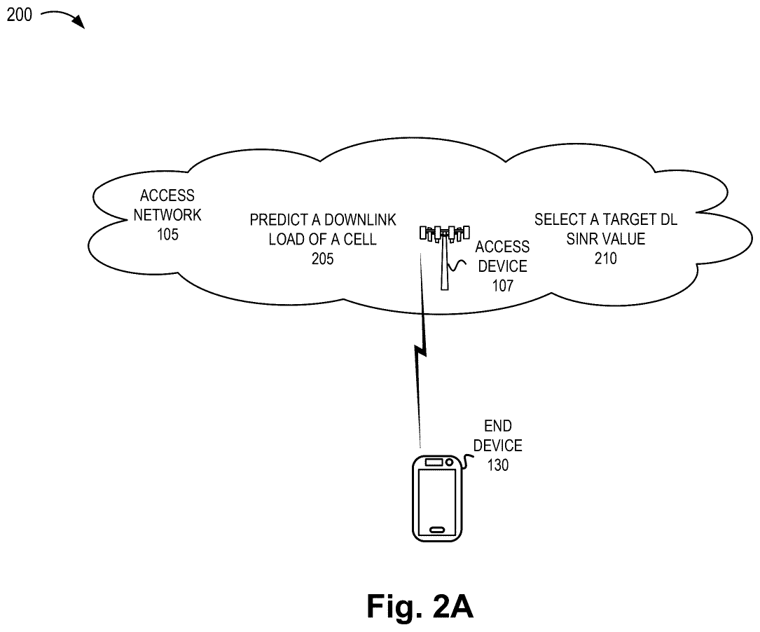

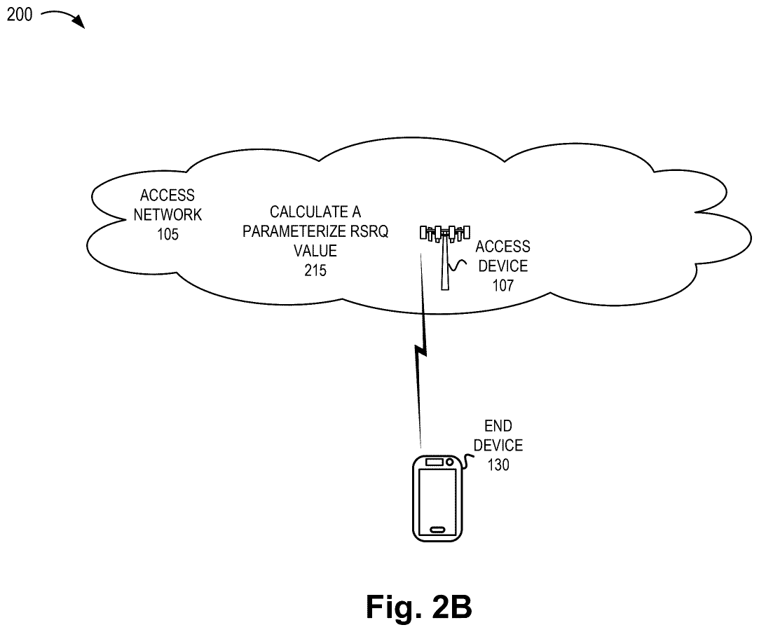

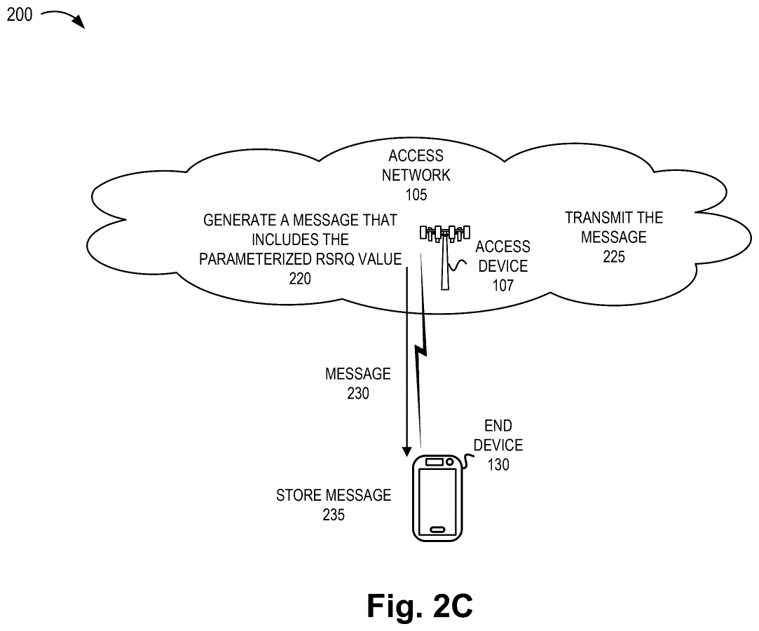

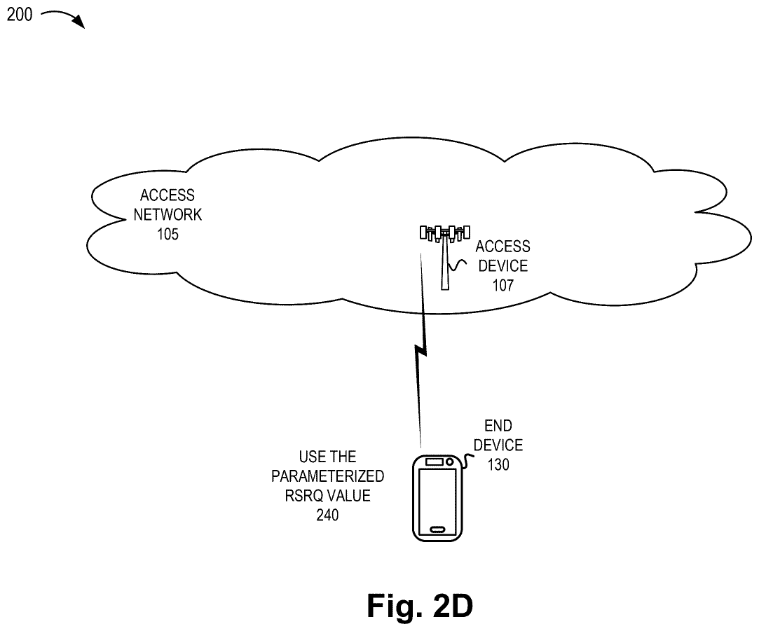

FIGS. 2A-2D is a diagram illustrating an exemplary process 200 of an exemplary embodiment of the load and SINR-based RSRQ for cell selection and reselection service. As illustrated, process 200 may involve exemplary network devices, such as access device 107. Process 200 may further involve end device 130. The message illustrated and described is exemplary.

Process 200 may pertain to different contexts, as described herein. However, according to other exemplary embodiments of the load and SINR-based RSRQ for cell selection and reselection service, modifications to process 200 may be implemented to accommodate specific contexts and/or scenarios.

Access device 107 and end device 130 may each include logic that performs an operation or provides a function that is in accordance with a technical specification associated with a network standardizing body, such as 3GPP, 3GPP2, ITU, ETSI, GSMA, or the like. Additionally, access device 107 may include logic of the load and SINR-based RSRQ for cell selection and reselection service, as described herein. According to various exemplary embodiments, access device 107 may be implemented as a unified cellular station (e.g., an eNB, a gNB, a 6G cellular station, or the like) or a cellular RAN device of a split architecture (e.g., an RU+DU, a DU, a future generation split RAN device, or the like).

Referring to FIG. 2A, access device 107 may predict a DL load of a cell. For example, access device 107 may calculate a prospective DL cell load value pertaining to a future time period. The future time period may be a configurable duration (e.g., next 15 minutes, next hour, or some other duration of time). According to various exemplary embodiments, the DL cell load may pertain to one or multiple antennas (e.g., 1 DL transmit antenna, 2 DL transmit antennas, 4 DL transmit antennas, 8 DL transmit antennas, a DL Advanced Antenna System (AAS), etc.) and associated wireless service coverage area (e.g., a sector, a sub-sector, or another type of service coverage area associated with the cell). Depending on the parameterized RSRQ value, the prospective DL cell load may pertain to access device 107 or a neighboring access device 107 (not shown). For example, the parameterized RSRQ value may pertain to a serving cell or a neighbor cell regarding cell reselection. According to some exemplary embodiments, the DL load of the cell may be predicted based on a statistical metric (e.g., average value, weighted average, etc.) during the future time period.

According to various exemplary embodiments, access device 107 may predict the prospective DL load of the cell based on an AI/ML model, analysis of historical DL load values associated with the cell, or the like. According to some exemplary embodiments, access device 107 may share a prospective DL load value with a neighboring access device 107 and vice versa via control plane messaging.

According to an exemplary embodiment, the configuration of a radio frame structure may be implemented according to a network standard in view of the RAT (e.g., 4G LTE, 5G NR, etc.). For example, an LTE sub-frame may include 2 slots and 2 resource blocks for each antenna in which each resource block includes 84 resource elements (REs). An RE may be configured or allocated to transmit data, transmit nothing, or transmit a reference signal (RS). According to another example, a 5G radio frame may include resource blocks, resource grid elements, slot format, and so forth. According to an exemplary embodiment, other parameters may be defined, such as RSRP, RSRQ, SINR, received signal strength indication (RSSI), and other parameters that may be used in relation to a cell selection or reselection criteria.

Based on the configuration of the radio frame and the antenna configuration, access device 107 may calculate the prospective DL load value. According to some exemplary embodiments, the prospective DL load value may be calculated as a normalized value.

According to an exemplary embodiment, access device 107 may predict the DL load of the cell according to the following exemplary expressions or considerations. For example, access device 107 may calculate a prospective DL LTE sub-frame load value based on an LTE sub-frame configuration. By way of further example, consider a 4-transmit antenna array, which for each antenna port, the antenna configuration supports 2 resource blocks in which each resource block=84 REs for 1 time slot during which there are 7 symbols. This exemplary configuration is in accordance with FIG. 6.10.1.2-1 of 3GPP TS 36.211 v 18.0.1 (2024 April), which is incorporated herein by reference. According to this example, during the 2 time slots of the LTE sub-frame, the antenna configuration may allocate 8 REs for transmitting a reference signal (i.e., each resource block may include 4 REs for transmitting a reference signal), and 16 REs for transmitting no data.

The DL LTE sub-frame load for the cell on a per antenna port basis may range from 0-1. Access device 107 may consider or calculate an active usage variable loading value. For example, according to an exemplary expression:

$$Active\_usage \_variable \_load = DL\_LET \_sub - frame\_load - ( 8 / 168 ) ) \qquad ( 1 )$$

According to other exemplary implementations, expression (1) may include minimum and maximum parameters/values to ensure the load is within the limits between 0-1. For example, according to an exemplary expression:

$$Active\_usage \_variable \_load = min ( max ( 0 , Cell\_DL PRB loading - ( 8 / 168 ) ) , \{ ( ( 168 - 16 ) / 168 \} ) \qquad ( 1 a )$$

According to an exemplary embodiment, access device 107 may normalize the active_usage_variable load value based on the following exemplary expression:

$$Normalized\_active - usage\_variable \_load = active\_usage \_variable \_load * ( 1.105 ) , \qquad ( 2 )$$

in which “1.105” may be derived from (168/(168-16)), in which “168” relates to the REs in the 2 resource blocks, and “16” relates to the 16 REs, as described herein.

According to an exemplary embodiment, access device 107 may calculate a number of active REs according to the following exemplary expression:

$$Active REs = 4 + ( normalized\_active \_usage \_variable \_load ) * 32 , \qquad ( 3 )$$

in which “4” may refer to the number of used REs during the first symbol (e.g., 4 REs configured to transmit the reference signal during the first symbol across the 4 antenna ports) and “32” may refer to the number of unused REs across the 4 antenna ports during the first symbol (e.g., 4 REs are configured to transmit the reference signal, 12 REs are configured to transmit nothing, and there are a total of 48 REs during the first symbol across the 4 antenna ports) (i.e., 48 REs−16 REs=32 REs).

According to an exemplary embodiment, with reference to a 2x-antenna system, expression (3) above may be rewritten according to the following expression:

$$Active REs = 4 + ( normalized\_active \_usage \_variable \_load ) * 16 , \qquad ( 3 a )$$

in which “4” may refer to the number of used REs during the first symbol (i.e., 4 REs configured to transmit the reference signal during the first symbol across the 2 antenna ports) and “16” may refer to the number of unused REs across the 2 antenna ports during the first symbol (i.e., 24 REs−8 REs=16 REs). For the 2x-antenna system, expression (1) (or (1a)) and a slightly modified expression (2) may also be used to calculate the corresponding parameter values (e.g., normalized active usage variable load), as described herein, such that the modified expression (2) may be rewritten according to the following exemplary expression:
in which “1.05” may be derived from (168/(168−8)), in which “168” relates to the REs in the 2 resource blocks, and “8” relates to the 8 REs configured to not transmit data in a 2Tx antenna system.

As further illustrated, access device 107 may select a target DL SINR value 210. For example, the target DL SINR value may pertain to a particular context or scenario in which end device 130 may perform a cell selection or a cell reselection procedure, as described herein. By way of example, the target DL SINR value may pertain to a particular mode of end device 130 (e.g., an idle mode, a connected mode, etc.), a RAT (e.g., 4G, 5G, or a future generation RAT), cell selection or cell reselection, and potentially other contexts, such as a priority (e.g., lower, equal, higher), serving cell versus target or neighbor cell, a particular event (e.g., measurement event types A, B, etc.), and other radio connectivity scenarios (e.g., HO, CA, etc.), as described herein. For the sake of description purposes only, the target DL SINR value may be implemented as 0 dB, 3 dB, 5 dB, or some other target dB value that is appropriate in view of the context to which the target dB value pertains. According to an exemplary embodiment, the target DL SINR value may be implemented as a linear value instead of a logarithmic scale, such as the decibel scale.

According to some exemplary embodiments, the target DL SINR value may be pre-configured towards a particular context. For example, a network administrator may configure target DL SINR values for various contexts and scenarios, as described herein. According to other exemplary embodiments, the target DL SINR value may be calculated based on an AI/ML model that may optimize the performance of access device 107, a set of access devices 107, and/or access network 105 (in whole or in part) in terms of radio connection management and the like relative to end devices 130, as well as other performative criteria regarding end devices 130. The target DL SINR values may be dynamic values based on time of day and cell (e.g., frequency/frequency band) associated with access device 107.

Referring to FIG. 2B, access device 107 may calculate a parameterized RSRQ value 215. For example, access device 107 may calculate the parameterized RSRQ value based on the prospective DL cell load and the target DL SINR value. The context of the RSRQ value may align with the context of the target DL SINR value. For example, when the target DL SINR value pertains to cell selection for end device 130 when in idle mode in an LTE environment, the parameterized RSRQ value may correspond to this context. For example, the parameterized RSRQ value may be implemented as an RSRQ threshold value, such as a Q_{qualmin} value.

According to an exemplary embodiment, access device 107 may calculate the parameterized RSRQ value according to the following exemplary expression:

$$RSRQ = 1 / ( Active REs ) * ( 1 + ( 1 / target DL SINR ) ) \qquad ( 4 )$$

According to an exemplary embodiment, access device 107 may convert the RSRQ value to the dB domain.

Referring to FIG. 2C, access device 107 may generate a message that includes the parameterized RSRQ value 220. For example, according to an exemplary embodiment, access device 107 may generate a SIB message of a particular type (e.g., Type 1, Type 2, etc.) depending on the context to which the parameterized RSRQ value pertains, network standards, and the like. Access device 107 may transmit the message 225 to end device 130. End device 130 may receive a message 230 (e.g., the SIB message) and store the message 235.

Referring to FIG. 2D, end device 130 may use the parameterized RSRQ value 240. For example, depending on various parameters associated with radio connectivity, end device 130 may apply the parameterized RSRQ value to a cell selection or a cell reselection procedure.

FIGS. 2A-2D illustrate an exemplary process 200, however, according to other exemplary embodiments and scenarios, process 200 may include additional operations or fewer operations, and different operations, or a sub-combination thereof, and/or additional messages or fewer messages, and different messages, or a sub-combination thereof, depending on the context.

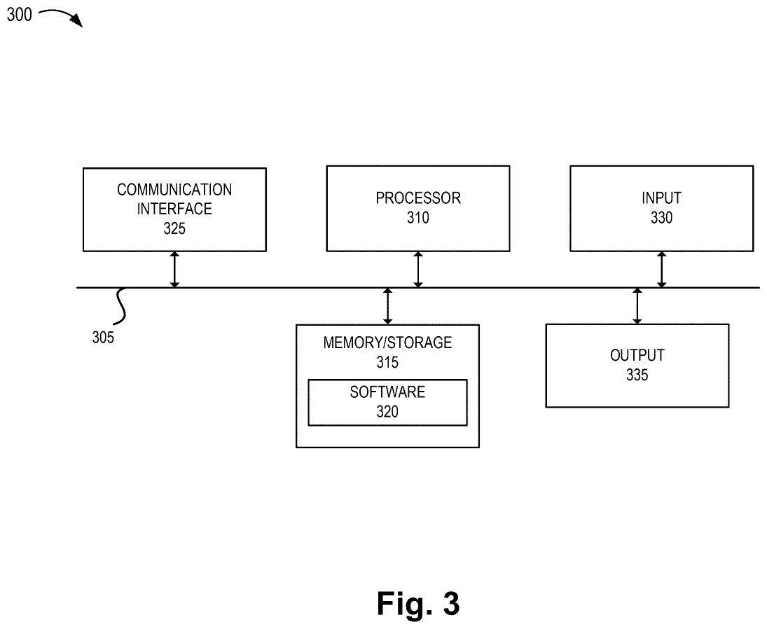

FIG. 3 is a diagram illustrating exemplary components of a device that may correspond to one or more of the devices illustrated and described herein. For example, device 300 may correspond to access device 107, external device 117, core device 122, end device 130, and/or other types of devices, as described herein. As illustrated in FIG. 3, device 300 includes a bus 305, a processor 310, a memory/storage 315 that stores software 320, a communication interface 325, an input 330, and an output 335. According to other embodiments, device 300 may include fewer components, additional components, different components, and/or a different arrangement of components than those illustrated in FIG. 3 and described herein.

Bus 305 includes a path that permits communication among the components of device 300. For example, bus 305 may include a system bus, an address bus, a data bus, and/or a control bus. Bus 305 may also include bus drivers, bus arbiters, bus interfaces, clocks, and so forth.

Processor 310 includes one or multiple processors, microprocessors, data processors, co-processors, graphics processing units (GPUs), application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, neural processing unit (NPUs), quantum processors, future generation processors or execution environments, and/or some other type of component that interprets and/or executes instructions and/or data. Processor 310 may be implemented as hardware (e.g., a microprocessor, etc.), a combination of hardware and software (e.g., a SoC, an ASIC, etc.), may include one or multiple memories (e.g., cache, etc.), etc.

Processor 310 may control the overall operation, or a portion of operation(s) performed by device 300. Processor 310 may perform one or multiple operations based on an operating system and/or various applications or computer programs (e.g., software 320). Processor 310 may access instructions from memory/storage 315, from other components of device 300, and/or from a source external to device 300 (e.g., a network, another device, etc.). Processor 310 may perform an operation and/or a process based on various techniques and/or technologies including, for example, multithreading, parallel processing, pipelining, interleaving, machine learning, artificial intelligence, etc.

Memory/storage 315 includes one or multiple memories and/or one or multiple other types of storage mediums. For example, memory/storage 315 may include one or multiple types of memories, such as, a random access memory (RAM), a dynamic RAM (DRAM), a static RAM (SRAM), a cache, a read only memory (ROM), a programmable ROM (PROM), an erasable PROM (EPROM), an electrically EPROM (EEPROM), a single in-line memory module (SIMM), a dual in-line memory module (DIMM), a flash memory (e.g., 2D, 3D, NOR, NAND, etc.), a solid state memory, and/or some other type of memory. Memory/storage 315 may include a hard disk (e.g., a magnetic disk, an optical disk, a magneto-optic disk, a solid-state component, etc.), a Micro-Electromechanical System (MEMS)-based storage medium, and/or a nanotechnology-based storage medium.

Memory/storage 315 may be external to and/or removable from device 300, such as, for example, a Universal Serial Bus (USB) memory stick, a dongle, a hard disk, a solid state drive, mass storage, off-line storage, cloud storage, or some other type of storing medium. Memory/storage 315 may store data, software, and/or instructions related to the operation of device 300.

Software 320 includes an application or a program that provides a function and/or a process. As an example, with reference to access device 107, software 320 may include an application that, when executed by processor 310, provides a function and/or a process of load and SINR-based RSRQ for cell selection and reselection service, as described herein. Software 320 may also include firmware, middleware, microcode, hardware description language (HDL), and/or other form of instruction. Software 320 may also be virtualized. Software 320 may further include an operating system.

Communication interface 325 permits device 300 to communicate with other devices, networks, systems, and/or the like. Communication interface 325 includes one or multiple wireless interfaces, optical interfaces, and/or wired interfaces. For example, communication interface 325 may include one or multiple transmitters and receivers, or transceivers. Communication interface 325 may operate according to a protocol stack and a communication standard.

Input 330 permits an input into device 300. For example, input 330 may include a keyboard, a mouse, a display, a touchscreen, a touchless screen, a button, a switch, an input port, a joystick, speech recognition logic, and/or some other type of visual, auditory, tactile, affective, olfactory, etc., input component. Output 335 permits an output from device 300. For example, output 335 may include a speaker, a display, a touchscreen, a touchless screen, a light, an output port, and/or some other type of visual, auditory, tactile, etc., output component.

As previously described, a network device may be implemented according to various computing architectures (e.g., in a cloud, etc.) and according to various network architectures (e.g., a virtualized function, PaaS, etc.). Device 300 may be implemented in the same manner. For example, device 300 may be instantiated, created, spun-up, uninstantiated, deleted, spun-down, or some other operational state during its life cycle (e.g., refreshed, paused, suspended, rebooting, or another type of state or status), using well-known virtualization technologies. For example, access device 107, core device 122, external device 117, and/or another type of network device or end device 130, as described herein, may be a virtualized device.

Device 300 may perform a process and/or a function, as described herein, in response to processor 310 executing software 320 stored by memory/storage 315. By way of example, instructions may be read into memory/storage 315 from another memory/storage 315 (not shown) or read from another device (not shown) via communication interface 325. The instructions that are stored by memory/storage 315 may configure and cause processor 310 to perform a function or a process described herein. Alternatively, for example, according to other implementations, device 300 performs a function or a process described herein based on the execution of hardware (processor 310, etc.).

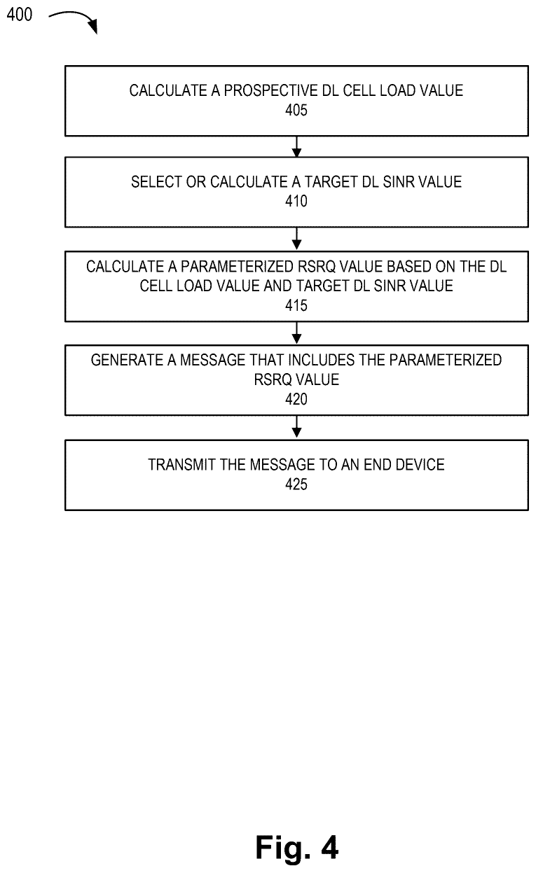

FIG. 4 is a flow diagram illustrating an exemplary process 400 of an exemplary embodiment of the load and SINR-based RSRQ for cell selection and reselection service. According to an exemplary embodiment, access device 107, such as an integrated RAN device or a split RAN device may perform a step of process 400. According to an exemplary implementation, processor 310 executes software 320 to perform a step of process 400, as described herein. Alternatively, a step may be performed by execution of only hardware.

In block 405, access device 107 may calculate a prospective DL cell load value. For example, access device 107 may calculate the prospective DL cell load value based on the resources associated with a cell of relevance, such as the number of antenna, radio frame structure (e.g., LTE, 5G, future generation, etc.) and associated air interface resources and configurations (e.g., resource grid, resource blocks, resource elements, slot format, etc.), prospective traffic demand, historical DL cell load values, the prospective day and time, and the like, as described herein.

In block 410, access device 107 may select or calculate a target DL SINR value. For example, access device 107 may select or calculate the target DL SINR value associated with a particular context or scenario, as described herein. According to an exemplary embodiment, the target DL SINR value may be implemented as a linear value.

In block 415, access device 107 may calculate a parameterized RSRQ value based on the DL cell load value and the target DL SINR value. According to some exemplary embodiments, access device 107 may calculate the parameterized RSRQ value based on expression (4) when certain parameters (e.g., LTE radio frame, antenna configuration, etc.) may be the same, as described herein. According to other exemplary embodiments, access device 107 may calculate the parameterized RSRQ value differently than expression (4) but based on the DL cell load value, the target DL SINR value, and various underlying parameters (e.g., RAT, radio frame structure, RSSI configuration parameters in 5G, antenna configuration, etc.), as described herein.

In block 420, access device 107 may generate a message that includes the parameterized RSRQ value. For example, access device 107 may generate a control plane message, such as a SIB message, as described herein. Depending on the context to which the parameterized RSRQ value pertains, access device 107 may select the appropriate control plane message. For example, in relation to an LTE wireless environment, access device 107 may select a SIB Type 3 message for cell reselection for inter/intra frequency (idle mode); a SIB Type 4 message for intra-frequency neighbor cell (idle mode); a SIB Type 5 for inter-frequency neighbor cell (idle mode), a SIB Type 24 message for NR neighbor cell (idle mode), and so forth. Additionally, for example, in relation to an NR wireless environment, access device 107 may select a SIB Type 2 message for cell reselection for inter/intra frequency and some inter-RAT handover (idle mode); a SIB Type 3 message for intra-frequency neighbor cell (idle mode); a SIB Type 4 message for inter-frequency neighbor cell (idle mode), a SIB Type 5 message for inter-RAT cell selection, and so forth.

In block 425, access device 107 may transmit the message. For example, access device 107 may transmit the control plane message, such as the SIB message or another type of control plane message, to end device 130.

FIG. 4 illustrates an exemplary process 400 of the load and SINR-based RSRQ for cell selection and reselection service, according to other exemplary embodiments, the load and SINR-based RSRQ for cell selection and reselection service may perform additional operations, fewer operations, and/or different operations than those illustrated and described. For example, according to other exemplary embodiments, one or more steps or operations of process 400 may be performed by a network device other than access device 107. Additionally, or alternatively, one or more steps of process 400 may be collaboratively performed by access device 107 and another network device, which may or may not reside in access network 105. For example, the network device may be implemented in core network 120, external network 115 (e.g., an edge network, etc.), an Operations, Administration, and Management (OAM) system, an AI/ML device, core device 122, external device 117 (e.g., edge server, etc.), and so forth.

As set forth in this description and illustrated by the drawings, reference is made to “an exemplary embodiment,” “exemplary embodiments,” “an embodiment,” “embodiments,” etc., which may include a particular feature, structure, or characteristic in connection with an embodiment(s). However, the use of the phrase or term “an embodiment,” “embodiments,” etc., in various places in the description does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The foregoing description of embodiments provides illustration but is not intended to be exhaustive or to limit the embodiments to the precise form disclosed. Accordingly, modifications to the embodiments described herein may be possible. For example, various modifications and changes may be made thereto, and additional embodiments may be implemented, without departing from the broader scope of the invention as set forth in the claims that follow. The description and drawings are accordingly to be regarded as illustrative rather than restrictive.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items. The word “exemplary” is used herein to mean “serving as an example.” The term “substantially” is used herein to represent a degree by which a quantitative representation may vary from a stated reference without resulting in a change in the basic function of the subject matter at issue.

Any embodiment or implementation described as “exemplary” is not necessarily to be construed as preferred or advantageous over other embodiments or implementations.

In addition, while a series of blocks has been described regarding the process illustrated in FIG. 4, the order of the blocks may be modified according to other embodiments. Further, non-dependent blocks may be performed in parallel. Additionally, other processes described in this description and illustrated in the drawings may be modified and/or non-dependent operations may be performed in parallel.

Embodiments described herein may be implemented in many different forms of software executed by hardware. For example, a process or a function may be implemented as “logic” or a “component.” The logic or the component may include, for example, hardware (e.g., processor 310, etc.), or a combination of hardware and software (e.g., software 320).

Embodiments have been described without reference to the specific software code because the software code can be designed to implement the embodiments based on the description herein and commercially available software design environments and/or languages. For example, diverse types of programming languages including, for example, a compiled language, an interpreted language, a declarative language, or a procedural language may be implemented.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processor 310) of a device. A non-transitory storage medium includes one or more of the storage mediums described in relation to memory/storage 315. The non-transitory computer-readable storage medium may be implemented in a centralized, distributed, or logical division that may include a single physical memory device or multiple physical memory devices spread across one or multiple network devices.

To the extent the aforementioned embodiments collect, store, or employ personal information of individuals, it should be understood that such information shall be collected, stored, and used in accordance with all applicable laws concerning protection of personal information. Additionally, the collection, storage and use of such information can be subject to the consent of the individual to such activity, for example, through well known “opt-in” or “opt-out” processes as can be appropriate for the situation and type of information. Collection, storage, and use of personal information can be in an appropriately secure manner reflective of the type of information, for example, through various encryption and anonymization techniques for particularly sensitive information.

No element, act, or instruction set forth in this description should be construed as critical or essential to the embodiments described herein unless explicitly indicated as such.

All structural and functional equivalents to the elements of the various aspects set forth in this disclosure that are known or later become known are expressly incorporated herein by reference and are intended to be encompassed by the claims.

What is claimed is:

1. A method comprising:
calculating, by a network device, a prospective downlink (DL) cell load value;
selecting, by the network device, a target DL signal-to-interference-plus-noise ratio (SINR) value pertaining to a cell selection context or a cell reselection context;
calculating, by the network device, a reference signal received quality (RSRQ) value based on the prospective DL cell load value and the target DL SINR value;
generating, by the network device, a message that includes the RSRQ value; and
transmitting, by the network device, the message to an end device.

2. The method of claim 1, wherein the cell selection context or the cell reselection context pertains to the end device in idle mode.

3. The method of claim 1, wherein the cell reselection context pertains to the end device in connected mode.

4. The method of claim 1, wherein the cell reselection context pertains to an inter-frequency priority.

5. The method of claim 1, wherein the RSRQ value is an RSRQ threshold value that pertains to a measurement event in a Fourth Generation (4G) or a Fifth Generation (5G) wireless environment.

6. The method of claim 1, wherein the calculating of the prospective DL cell load value further comprises:
determining, by the network device, a number of antenna and a radio frame structure pertaining to a cell to which the prospective DL cell load value pertains.

7. The method of claim 1, wherein the network device includes a radio access network (RAN) device, and the prospective DL cell load value pertains to another RAN device.

8. The method of claim 1, wherein the network device is an integrated radio access network (RAN) device or a split RAN device.

9. A network device comprising:
a processor that is configured to:
calculate a prospective downlink (DL) cell load value;
select a target DL signal-to-interference-plus-noise ratio (SINR) value pertaining to a cell selection context or a cell reselection context;
calculate a reference signal received quality (RSRQ) value based on the prospective DL cell load value and the target DL SINR value;
generate a message that includes the RSRQ value; and
transmit the message to an end device.

10. The network device of claim 9, wherein the cell selection context or the cell reselection context pertains to the end device in idle mode.

11. The network device of claim 9, wherein the cell reselection context pertains to the end device in connected mode.

12. The network device of claim 9, wherein the cell reselection context pertains to an inter-frequency priority.

13. The network device of claim 9, wherein the RSRQ value is an RSRQ threshold value that pertains to a measurement event in a Fourth Generation (4G) or a Fifth Generation (5G) wireless environment.

14. The network device of claim 9, wherein when calculating the prospective DL cell load value, the processor is further configured to:
determine a number of antenna and a radio frame structure pertaining to a cell to which the prospective DL cell load value pertains.

15. The network device of claim 9, wherein the network device includes a radio access network (RAN) device, and the prospective DL cell load value pertains to another RAN device.

16. The network device of claim 9, wherein the network device is an integrated radio access network (RAN) device or a split RAN device.

17. A non-transitory computer-readable storage medium storing instructions executable by a processor of a network device, wherein the instructions are configured to:
calculate a prospective downlink (DL) cell load value;
select a target DL signal-to-interference-plus-noise ratio (SINR) value pertaining to a cell selection context or a cell reselection context;
calculate a reference signal received quality (RSRQ) value based on the prospective DL cell load value and the target DL SINR value;
generate a message that includes the RSRQ value; and
transmit the message to an end device.

18. The non-transitory computer-readable storage medium of claim 17, wherein the cell reselection context pertains to an inter-frequency priority.

19. The non-transitory computer-readable storage medium of claim 17, wherein the RSRQ value is an RSRQ threshold value that pertains to an event in a Fourth Generation (4G) or a Fifth Generation (5G) wireless environment.

20. The non-transitory computer-readable storage medium of claim 17, wherein the network device includes a radio access network (RAN) device, and the prospective DL cell load value pertains to another RAN device.
